(19) United States
(12) Patent Application Publication
(10) Pub. No.: US 2024/0408518 A1
(43) Pub. Date: Dec. 12, 2024

(54) SPIN-ON FILTER ASSEMBLY FOR EXISTING FILTER HEAD WITH REUSABLE HOUSING AND FILTER ELEMENT ADAPTOR AND DISPOSABLE CORELESS ELEMENT

(71) Applicant: Schroeder Industries, LLC, Leetsdale, PA (US)

(72) Inventors: Michael J. Schmitt, Pittsburgh, PA (US); David L. Cowder, Coraopolis, PA (US); Christopher B. Bortnik, Warrendale, PA (US); Scott F. Surdick, Pittsburgh, PA (US)

(21) Appl. No.: 18/737,707

(22) Filed: Jun. 7, 2024

Related U.S. Application Data
(60) Provisional application No. 63/471,742, filed on Jun. 7, 2023.

(51) Int. Cl. B01D 29/15; B01D 35/30

(52) U.S. Cl. CPC B01D 29/15; B01D 35/306; B01D 2201/30

(57) ABSTRACT

A spin-on filter assembly with replaceable coreless element includes a reusable spin-on housing including a filter bowl; a reusable adaptor removeably coupled to the reusable spin-on housing, including a coupling, such as a threaded coupling for removably coupling the reusable adaptor to a filter head; and a replaceable disposable nonmetal coreless filter element removably mounted on the reusable adaptor.

### RELATED APPLICATIONS

This application claims priority to provisional U.S. patent application Ser. No. 63/471,742 filed Jun. 7, 2023, titled “Spin-on Filter Assembly for Existing Filter Head with Reusable Housing and Filter Element Adaptor and Disposable Coreless Element” which application is incorporated herein by reference in its entirety.

### BACKGROUND INFORMATION

### 1. Field of the Invention

The present invention relates to filter assemblies, and more particularly, the applicant has developed a spin-on filter assembly for an existing filter head with a reusable housing, a filter element adaptor and a replaceable eco-friendly coreless element.

### 2. Background Information

The concept of coreless replaceable filter elements is generally known in conventional filter housing configurations. The concept of a coreless filter element is known to provide a lighter weight, more environmentally-friendly (ecofriendly) alternative to filter elements with a metal core. Used in conjunction with a permanent metal core, which conventionally is integrated with the housing, coreless filter elements are easily pulled from the core when plugged. Being coreless, they are significantly lighter in weight, facilitating both removal and replacement. Disposal costs are less for coreless elements because they are crushable, reducing volume up to 50% over metal-cored elements.

Spin-on filter assemblies, or simply spin-on filters, are known. Automobile oil filters represent a common well-known example of this filter assembly type. FIG. 1 illustrates an aluminum, industrial version of this spin on filter assembly on an existing filter head 10. Historically this design consists of a metal canister 20 housing a filter media, with a top cap, or head, threaded directly to a threaded post that forms part of the filter flow-path. These are also called canister filters and are generally disposed of completely when the media is clogged

These conventional spin-on filter assemblies create difficulties in disposal as the metal housing adds waste and volume and prevents incineration as a method of disposal.

The inventors have proposed some cost effective, efficient, spin-on filter assemblies with a reusable housing and replaceable eco-friendly coreless elements as outlined in U.S. Patent Publication 2023-0113056 and U.S. Pat. No. 11,504,658, which are incorporated herein by reference.

There still remains a need to create designs that are more readily adopted in particular applications. Thus, there remains a need in the field for a spin-on filter assembly with a reusable housing and replaceable eco-friendly elements.

### SUMMARY OF THE INVENTION

This invention is directed to a cost effective, efficient, spin-on filter assembly with a reusable housing and replaceable eco-friendly coreless element.

One aspect of the invention provides a spin-on filter assembly with replaceable coreless element includes a reusable spin-on housing including a filter bowl; a reusable adaptor removeably coupled to the reusable spin-on housing, including a coupling for removably coupling the resuable adaptor to a filter head; and a replaceable disposable coreless filter element removably mounted on the reusable adaptor.

One aspect of the invention provides a spin-on filter assembly with replaceable coreless element comprising: a reusable spin-on housing including a filter bowl; a reusable adaptor removeably coupled to the reusable spin-on housing, including a coupling for removably coupling the resuable adaptor to a filter head, wherein the coupling for removably coupling the resuable adaptor to a filter head includes threads engagable with matching threads on the filter head, and including radially spaced openings in the adaptor providing fluid communication between the filter head and the filter bowl; and a replaceable disposable coreless filter element removably mounted on the reusable adaptor wherein the filter assembly is outside in flow whereby the flow begins through an inlet of the filter head into the interior of the bowl via the openings in the adaptor, wherein the flow proceeds through a media of the element to the interior of the element and the flow then proceeds to an outlet of the filter head.

One aspect of the invention provides a spin-on filter assembly with replaceable coreless element comprising: a reusable spin-on housing including a filter bowl; a reusable adaptor removeably coupled to the reusable spin-on housing, including a coupling for removably coupling the reusable adaptor to a filter head, wherein the coupling for removably coupling the reusable adaptor to a filter head includes threads engagable with matching threads on the filter head, and including radially spaced openings in the adaptor providing fluid communication between the filter head and the filter bowl; and a replaceable disposable coreless filter element removably mounted on the reusable adaptor wherein the filter assembly is inside out flow whereby the flow begins through an inlet of the filter head into the interior of the element, wherein the flow proceeds through a media of the element to the filter bowl and the flow then proceeds through the radially spaced opening in the to an outlet of the filter head.

The spin-on filter assembly with replaceable coreless element according to one aspect of the present invention may provide wherein the coupling for removably coupling the reusable adaptor to a filter head includes threads engagable with matching threads on the filter head. The spin-on filter assembly with replaceable coreless element according to one aspect of the present invention may provide wherein the filter bowl is threaded to the reusable adaptor. The spin-on filter assembly with replaceable coreless element according to one aspect of the present invention may further include radially spaced openings in the adaptor providing fluid communication between the filter head and the filter bowl. The spin-on filter assembly with replaceable coreless element according to one aspect of the present invention may provide wherein the radially spaced openings in the adaptor are configured to serve as lug receiving elements to assist in decoupling the housing from the adaptor. The spin-on filter assembly with replaceable coreless element according to one aspect of the present invention may provide wherein the replaceable disposable coreless filter element includes lugs spaced to be received in the radially spaced openings in the adaptor to assist in decoupling the housing from the adaptor. The spin-on filter assembly with replaceable coreless element according to one aspect of the present invention may provide wherein the replaceable disposable coreless filter element includes a lower endcap with an integral cross bar to which the lugs are mounted. The spin-on filter assembly with replaceable coreless element according to one aspect of the present invention may provide wherein the adaptor includes a base with filter element alignment slots on the base that receive cooperating ears on the filter element assure the filter element is properly aligned with the adaptor. The spin-on filter assembly with replaceable coreless element according to one aspect of the present invention may provide wherein the filter element alignment slots on the base that receive cooperating ears on the filter element assure the filter element is properly aligned with the adaptor of alignment are configured to be twisted into to lock the components together. The spin-on filter assembly with replaceable coreless element according to one aspect of the present invention may provide wherein the crossbar is configured whereby a screwdriver could be extended through the cross bar.

These and other advantages of the present invention will be described below in connection with the associated figures in which like reference numerals represent like elements throughout.

### BRIEF DESCRIPTION OF THE SEVERAL FIGURES

FIG. 1 is a perspective view of a prior art spin-on filter assembly.

FIG. 2 is a perspective view of a spin-on filter assembly for an existing filter head with a reusable housing and a filter element adaptor and a disposable coreless element according to one embodiment of the present invention.

FIG. 3 is a top plan view of the filter assembly of FIG. 2.

FIG. 4 is an elevation sectional view of the filter assembly of FIG. 2 taken along line A-A of figured 3.

FIG. 5 is an exploded view of the filter assembly of FIG. 2.

FIG. 6A is a perspective schematic view of the removal of the reusable filter bowl from the adaptor and element utilizing a separate element and FIG. 6B is an exploded view of FIG. 6A.

FIG. 7 is a view of a spin-on filter assembly for an existing filter head with a reusable housing and a filter element adaptor and a disposable coreless element according to one embodiment of the present invention.

FIG. 8 is a top plan view of the spin-on filter assembly of FIG. 7.

FIG. 9 is an elevation sectional view of the filter assembly of FIG. 7 taken along line A-A of figured 8.

FIG. 10 is an exploded view of the filter assembly of FIG. 7.

FIG. 11A is a perspective schematic view of the removal of the reusable filter bowl from the adaptor and element utilizing a separate element.

FIG. 11B is a top plan view showing slots in the bottom endcap of the filter element the removal of the reusable filter bowl from the adaptor and element utilizing a screwdriver.

FIG. 11C is a perspective partially section view showing slots in the bottom endcap of the filter element the removal of the reusable filter bowl from the adaptor and element utilizing a screwdriver.

FIG. 11D is a perspective schematic view of the removal of the reusable filter bowl from the adaptor and element utilizing a separate element and a screwdriver.

FIG. 11E is a perspective schematic view of the removal of the reusable filter bowl from the adaptor and element utilizing a separate element and a wrench.

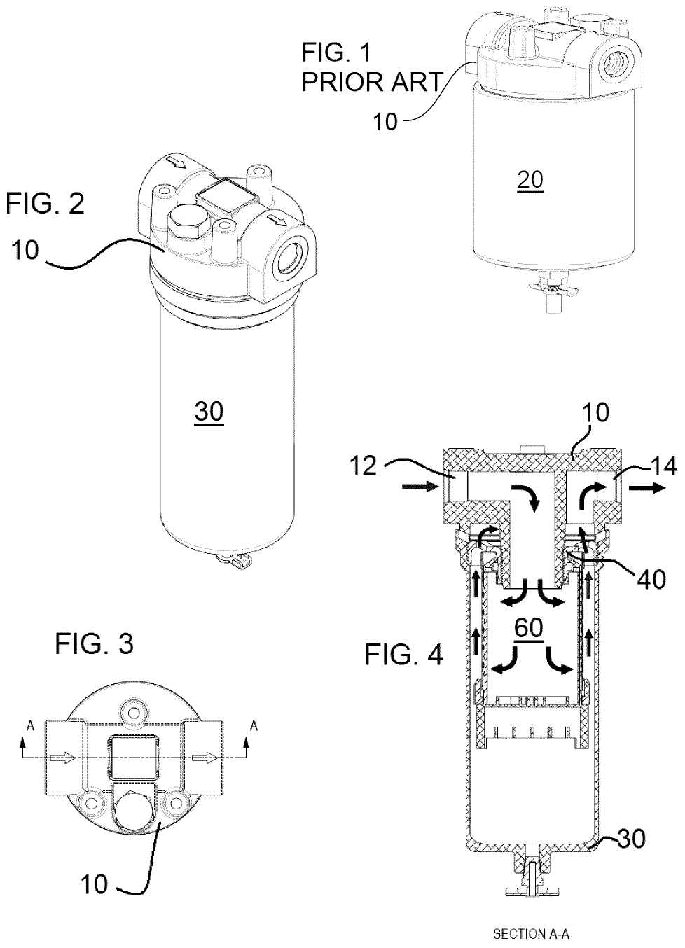

### DESCRIPTION OF THE PREFERRED EMBODIMENT

The present invention is directed to a spin-on filter assembly for an existing filter head 10 with a reusable housing or filter bowl 30 and reusable filter element adaptor 40 and a replaceable eco-friendly nonmetal coreless element 60.

FIG. 2 is a perspective view of a spin-on filter assembly with replaceable eco-friendly coreless element 60 according to one embodiment of the present invention. The overall design concept can be described as a spin-on “can” housing or filter bowl 30 and adaptor 40 that are re-usable together with a coreless filter element 60, or cartridge element 60.

The filter head 10, filter bowl or housing 30 and the adapter 40 can be made of metal as they are reused with multiple elements 60. The assembly of the present invention yields numerous benefits, including: i) a reduction of the waste footprint by eliminating the traditional steel disposable spin-on can as the coreless element 60 can be crushed, shredded and burned, ii) an elimination of the outsourcing of the “canning” process, and iii) wide or nearly universal application as nearly any current media type can be incorporated in the cartridge element 60.

The spin-on filter assembly of the present invention is easily designed to fit the following known conventional spin-on heads, namely those made by Schroeder, Hydac, Parker, Donaldson, Pall and Zinga.

FIG. 4 is a side elevation section view of the filter assembly of FIG. 2 taken along line A-A of the top plan view of FIG. 3. FIG. 4 also schematically illustrates the inside out flow pattern for the filter assembly of FIG. 2.

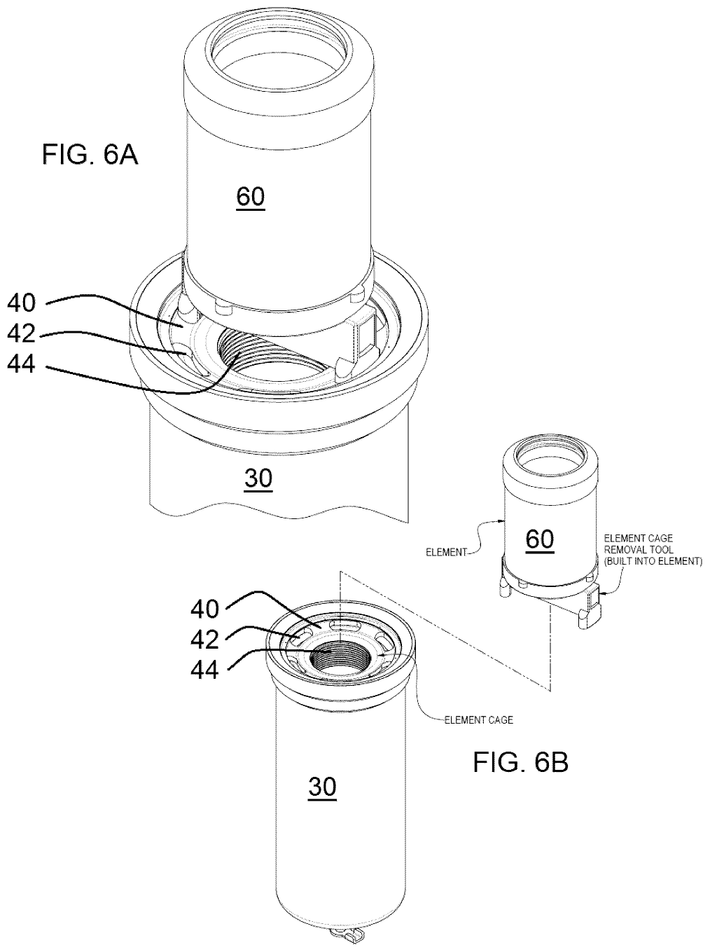

The flow begins through the inlet 12 of the filter head 10 into the interior of the element 60. The flow proceeds through the media 64 of the element 60 and an element cage 48 of the adaptor 40 to the filter bowl 30. The flow then proceeds through radially spaced opening 42 in the adaptor 40 (see FIGS. 6A and B) to the outlet 14 of the filter head 10.

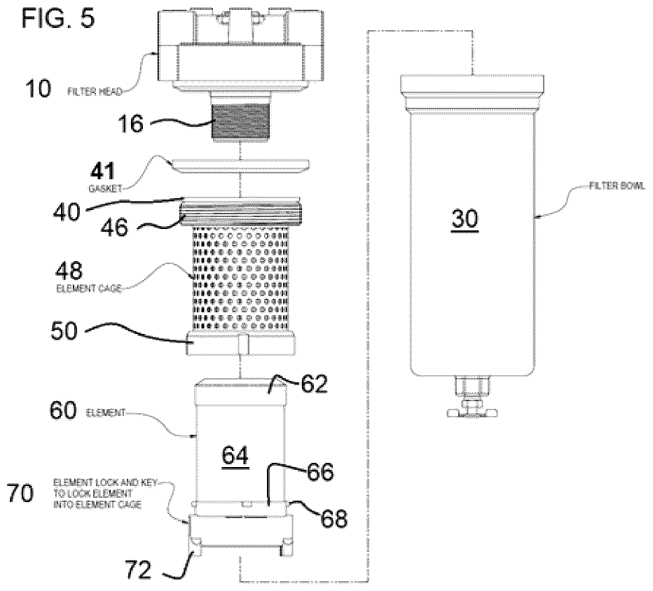

In addition to the inlet 12 and the outlet 14, the filter head 10 includes another important feature for the present invention. Specifically, the filter head 10 includes external coupling threads 16 that couple to internal threads 44 of the adaptor 40 that are shown in FIGS. 6A and 6B. As detailed below, the threads 44 allows the combined unit formed by the element 60, the adaptor 40 and the filter bowl or housing 30 to be threaded on and off the filter head 10 (via coupling threads 16) analogous to conventional spin on elements. As detailed below, the present invention allows a used element 60 to be decoupled from the filter bowl 30 and adaptor 40 and replaced with a new element 60 for continued use. The filter bowl 30 and adaptor 40 may be metal (such as aluminum or steel), and thus no metal ends up in landfills due to replacement of the element 60. As noted in FIG. 5 a gasket 41 may be used to add sealing between the combined unit formed by the element 60, the adaptor 40 and the filter bowl or housing 30 and the filter head 10.

The filter adaptor 40 includes the openings 42 and internal threads 44 as noted above. The filter adaptor 40 includes external threads 46 for coupling to matching internal threads on the top of the filter bowl 30. As detailed below the opening 42 serve as lug receiving elements for lugs 72 (of a separate element 60) to assist in decoupling the housing 30 from the adaptor 40 after the combined unit is removed from the filter head 10.

The filter adaptor 40 includes an external mesh support tube 48, also called an element cage, that is adjacent the media 64 of the element in the combined unit. The filter adaptor 40 includes a base 50 on the lower distal end of the external mesh support tube 48, with the base coupling to the key components or locking ears 68 of the element 60. Preferably this will be in the form of alignment slots receiving the ears 68 with grooves the ears (or lugs) can be twisted into to lock the components together. The filter element alignment slots (also called grooves or guideways) of the base 50 that receive cooperating ears 68 on the filter element 60 assure the filter element 60 is properly aligned with the adaptor 60 and a unique number and circumferential position of the slots and ears 68 can be used to assure the filter element 60 is rated for the specific intended application of the spin-on filter assembly associated with this adaptor 40. Namely the position and number of slots and cooperating ears 68 can change with different operating parameters, and only the filter element 60 rated for such use will have corresponding ears 68, whereby an operator is less likely to accidentally attempt to install a filter element 60 that is not rated for the specifics that the given spin-on filter assembly has been designed. Further, due to the mismatch of ears 68 and slots if a wrong element 60 is selected the assembly prevents such installation.

The coreless nonmetal ecofriendly filter element 60 of the filter assembly of FIG. 2 includes an upper endcap 62. The filter element 60 includes filter media 64, such as a pleated filter media, extending from the upper endcap 62 to the lower endcap 66 and configured to treat the fluid flowing there-through. The filter media 64 may be pleated media as described, or any desired media for the desired fluid filtration or treatment. The filter media 64 may be formed as composite media of distinct types. The filter media 64 may be coupled to the upper endcap 62 and the lower endcap 66 through adhesive such as epoxy. As mentioned above, the lower endcap 66 includes alignment ears 68 received in cooperating slots on the adaptor 40 to couple these elements together and permit decoupling thereof when the element 60 is to be replaced.

The lower endcap 66 additionally includes an integral cross bar 70 with lugs 72 and the end cap is generally a one-piece structure and may be injection molded. The integral cross bar 70 with lugs 72 offers a convenient place to grasp and manipulate the element 60 relative to the adaptor 40 to ease the coupling and decoupling of these components from each other. As noted above the lugs 72 are configured to be received within the opening 42 of the adaptor 40 such that a replacement element 60 can be used as an opening tool to separate the element 60 and adaptor 40 from the filter bowl 30.

FIG. 4 also schematically illustrates the inside out flow pattern for the filter assembly of FIG. 2 and the operational assembly. When there is a need to replace a used filer element 60 the operator first unthreads the assembly including the bowl 30 the adaptor 40 and element 60 from the filter head 10, disengaging threads 44 from 16 in a manner generally analogous to the removal operation of prior art spin on filters 20.

Secondly, after disengagement from the filter head 10 the operator unthreads or decouples the bowl 30 from the adaptor 40 and element 60, namely unthreading the filter bowl 30 from the threads 46 of the adaptor 40. As shown in FIGS. 6A and 6B, the lugs 72 of the replacement element 60 can be placed in the opening 42 on the adaptor 40 acting as a spanner tool to assist in this operation if needed. A screwdriver could be extended through the cross bar 70 of the replacement element to increase leverage if needed.

After disengagement of the bowl 30 from the adaptor 40 and element 60, the old element 60 is removed or disengaged from the adaptor 40 disengaging ears 68 from the locking elements in the base 50. The cross bar 70 and lugs 72 of the old element 60 may be gripped and used to assist in this removal.

Following removal of the old element 60, a new element 60 is then attached to the adaptor 40 by engaging the lugs or ears 68 with the receiving elements in the base 50 and the cross bar 70 and lugs 72 of the new element 60 may be gripped and used to assist in this coupling. Then the bowl 30 is threaded onto the threads 46 of the adaptor 40 and the assembled subassembly is coupled to the filter head 10 by threading threads 44 of the adaptor 40 onto threads 16 of the filter head 10.

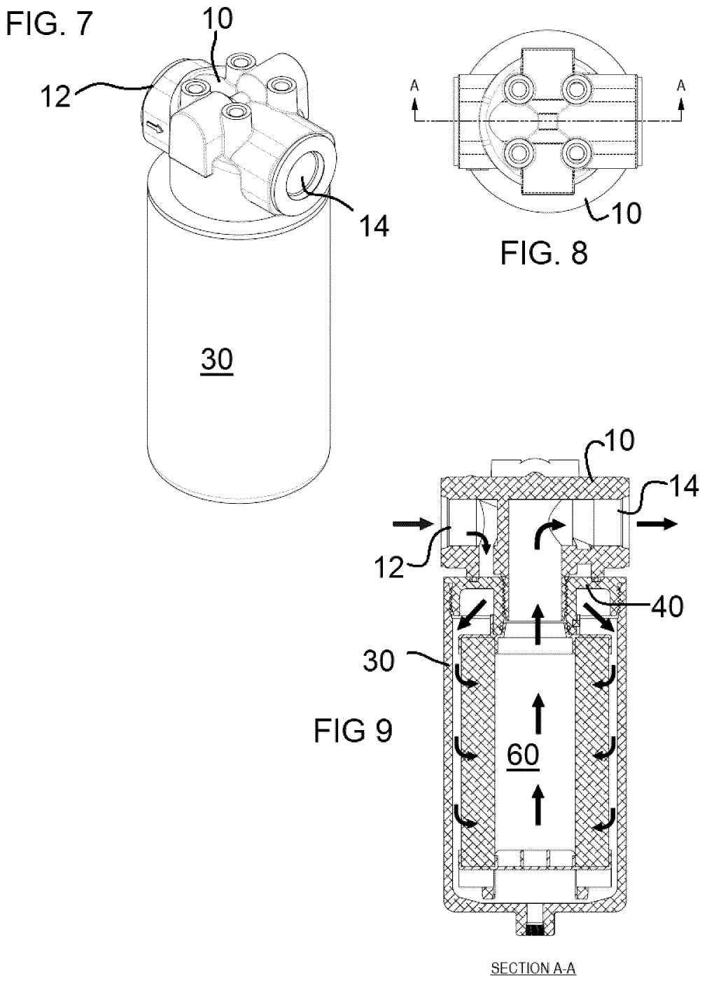

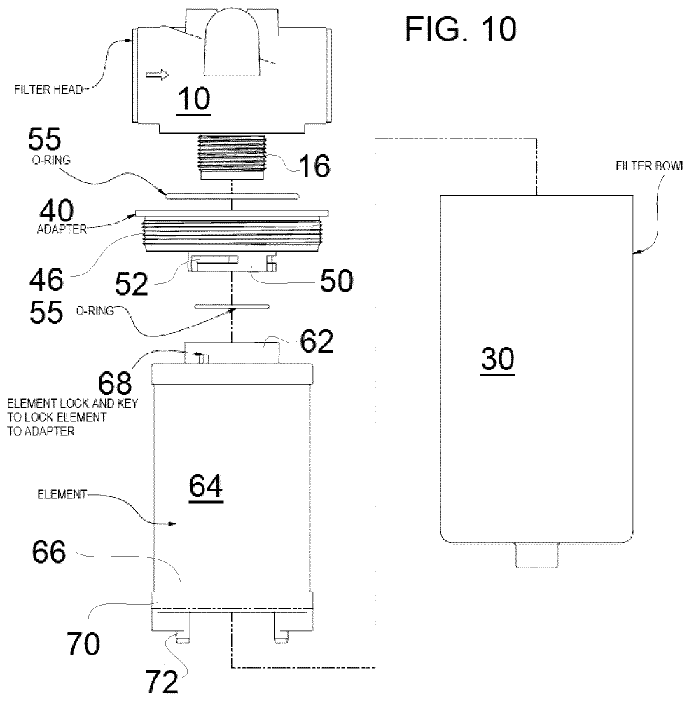

FIG. 7 is a perspective view of a spin-on filter assembly with replaceable eco-friendly coreless element 60 according to one embodiment of the present invention different from that of FIGS. 2-6A and 6B. The overall design concept can again be described as a spin-on “can” housing or filter bowl 30 and adaptor 40 that are re-usable together with a coreless filter element 60 or cartridge element.

The filter head 10, filter bowl or housing 30 and the adapter can be made of metal as they are reused with multiple elements 60. The assembly of the this embodiment of the present invention yields similar benefits as that of the earlier embodiment, including: i) a reduction of the waste footprint by eliminating the traditional steel disposable spin-on can as the coreless element 60 can be crushed, shredded and burned, ii) an elimination of the outsourcing of the “canning” process, and iii) wide or nearly universal application as nearly any current media recipe or type can be incorporated in the cartridge element 60.

The spin-on filter assembly of the present invention of FIG. 7 is also easily designed to fit the following known conventional spin-on heads such as those manufactured by Schroeder, Hydac, Parker, Donaldson, Pall and Zinga.

FIG. 9 is a side elevation section view of the filter assembly of FIG. 7 taken along line A-A of the top plan view of FIG. 8. FIG. 9 also schematically illustrates the outside in flow pattern for the filter assembly of FIG. 7. The flow is through the inlet 12 of the filter head 10 into the interior of the bowl 30 via opening 42 in the adaptor 40, then through the media 64 of the element 60 to the interior of the element 60, then through the outlet 14 of the filter head 10.

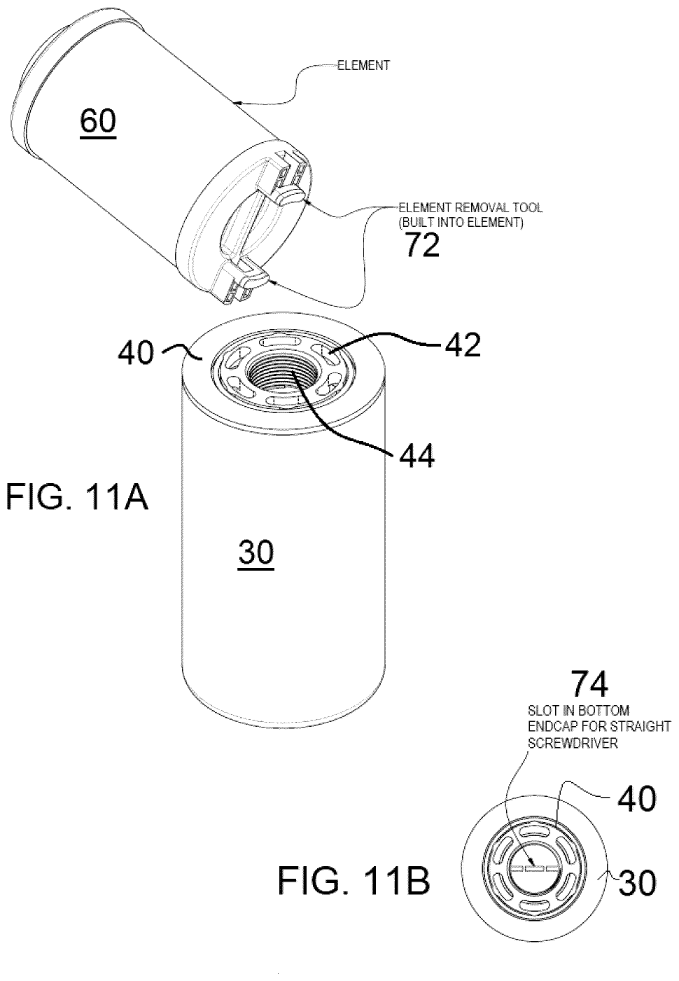

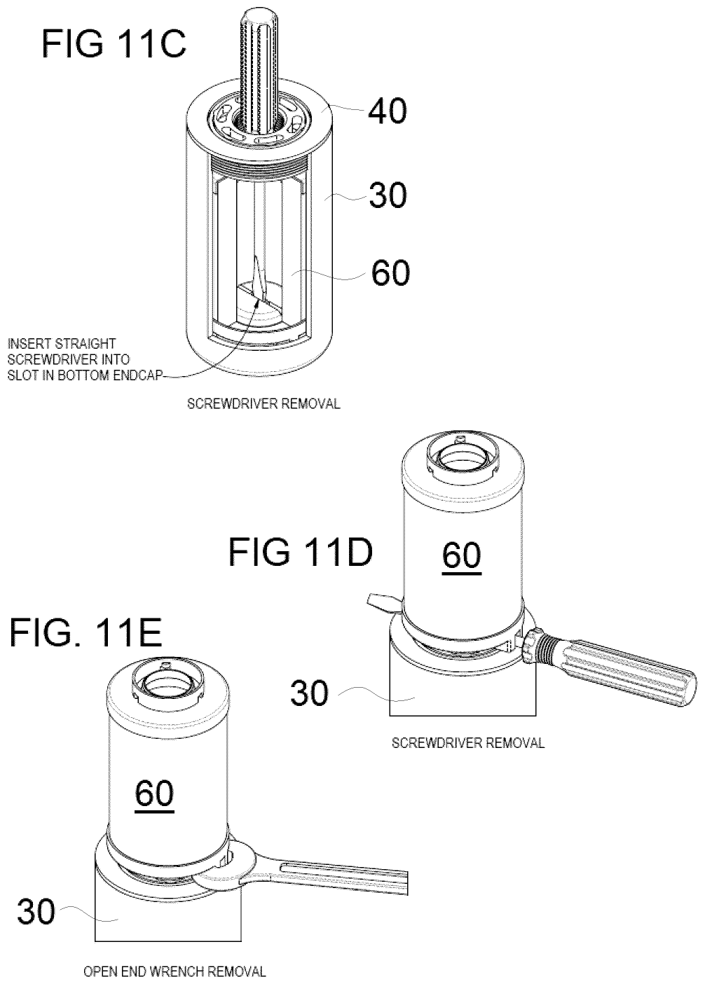

As discussed above, the filter head 10 includes external coupling threads 16 that couple to internal threads 44 of the adaptor 40 that are shown in FIGS. 11A-C. Similar to the embodiment of FIG. 2, in the embodiment of FIG. 7 the threads 44 allow the combined unit formed by the element 60, the adaptor 40 and the filter bowl or housing 30 to be threaded on and off the filter head 10 analogous to conventional spin on elements. The embodiment of FIG. 7 of the present invention also allows a used element 60 to be decoupled from the filter bowl 30 and adaptor 40 and replaced with a new element 60 for continued use. The filter bowl 30 and adaptor 40 may be metal (such as aluminum or steel) such that, again no metal is ending up in landfills with replacement of elements 60 of the present invention. As noted in FIG. 9, O-rings 55 (or gaskets 41 or combinations thereof) may be used to add sealing between the combined unit formed by the element 60, the adaptor 40 and the filter bowl or housing 30 and the filter head 10, or between the adaptor 40 and element 60 (as needed).

The filter adaptor 40 includes external threads 46 for coupling to matching internal threads on the top of the filter bowl 30. As shown in FIGS. 11A and 11D and 11E, the opening 42 serve as lug receiving elements for lugs 72 (of a separate element 60) to assist in decoupling the housing 30 from the adaptor 40 after the combined unit is removed from the filter head 10.

The filter adaptor 40 of the embodiment of FIG. 7 differs from the embodiment of FIG. 2 in that it does not include an external mesh support tube adjacent the media 64 of the element in the combined unit, mainly due to the outside in flow. The filter adaptor 40 includes a base 50 on a lower distal end of adaptor, with the base 50 coupling via grooves or alignment slots 52 to the key components or locking ears 68 of the element 60 (here in the top end cap 62). The alignment slots 62 receive the ears 68 and the ears 68 are twisted into position to lock the components together. The filter element alignment slots (also called grooves or guideways) 52 of the base 50 that receive cooperating ears 68 on the filter element 60 assure the filter element 60 is properly aligned with the adaptor 60 and a unique number and circumferential position of the slots 52 and ears 68 can be used to assure the filter element 60 is rated for the specific intended application of the spin-on filter assembly associated with this adaptor 40. Namely the position and number of slots 62 and cooperating ears 68 can change with different operating parameters, and only the filter element 60 rated for such use will have corresponding ears 68, whereby an operator is less likely to accidentally attempt to install a filter element 60 that is not rated for the specifics that the given spin-on filter assembly has been designed. Further, due to the mismatch of ears 68 and slots 52 if a wrong element 60 is selected the assembly prevents such installation.

The coreless ecofriendly filter element 60 of the filter assembly of FIG. 7 includes an upper endcap 62. The filter element 60 includes filter media 64, such as a pleated filter media, extending from the upper endcap 62 to the lower endcap 66 and configured to treat the fluid flowing there-through. The filter media 64 may be pleated media as described, or any desired media for the desired fluid filtration or treatment. The filter media 64 may be formed as composite media of distinct types. The filter media 64 may be coupled to the upper endcap 62 and the lower endcap 66 through adhesive such as epoxy. In the embodiment of FIG. 7 the upper endcap 62 includes alignment ears 68 received in cooperating slots 52 on the adaptor 40 to couple these elements together and permit decoupling thereof when the element 60 is to be replaced.

The lower endcap 66 additionally includes an integral cross bar 70 with lugs 72 and the lower end cap 66 is generally a one-piece structure and may be injection molded. The integral cross bar 70 with lugs 72 offers a convenient place to grasp and manipulate the element 60 relative to the adaptor 40 to ease the coupling and decoupling of these components from each other. As noted above the lugs 72 are configured to be received within the opening 42 of the adaptor 40 such that a replacement element 60 can be used as an opening tool to separate the element 60 and adaptor 40 from the filter bowl 30 as shown in FIGS. 11A, 11D and 11E.

FIG. 9 also schematically illustrates the outside in flow pattern for the filter assembly of FIG. 7 and the operational assembly. When there is a need to replace a used filer element 60 the operator first unthreads the bowl 30 from the filter head 10, disengaging threads 44 from 16 generally analogous to the operation of prior art spin on filters 20. Secondly, the operator unthreads or decouples the bowl 30 from the adaptor 40, namely unthreading the filter bowl 30 from the threads 46 of the adaptor 40. As shown in FIGS. 11A, 11D and 11E, the lugs 72 of the replacement element 60 can be placed in the opening 42 on the adaptor 40 acting as a spanner tool to assist in this operation if needed. A screwdriver could be extended through the cross bar 70 of the replacement element 60 as shown in FIG. 11D or a wrench used as shown in FIG. 11E to increase leverage if needed. Slots 74 in the end cap 66 shown in FIG. 11B can be provided to receive a screwdriver for added leverage as shown in FIG. 11C.

After disengagement of the bowl 30, the old element 60 is removed or disengaged from the adaptor 40 to disengage ears 68 from the locking elements in the base 50. The cross bar 70 and lugs 72 of the old element 60 may be gripped and used to assist in this removal. The new element 60 is then attached to the adaptor by engaging the lugs or ears 68 with the receiving elements in the base 50 and the cross bar 70 and lugs 72 of the new element 60 may be gripped and used to assist in this coupling. The bowl 30 is threaded onto the threads 46 of the adaptor 40 and the assembled subassembly is coupled to the filter head 10 by threading threads 44 of the adaptor 40 onto threads 16 of the filter head 10.

The preferred embodiments described above are illustrative of the present invention and not restrictive hereof. It will be obvious that various changes may be made to the present invention without departing from the spirit and scope of the invention. The precise scope of the present invention is defined by the appended claims and equivalents thereto.

What is claimed is:

1. A spin-on filter assembly with replaceable coreless element comprising:
a reusable spin-on housing including a filter bowl;
A reusable adaptor removeably coupled to the reusable spin-on housing, including a coupling for removably coupling the reusable adaptor to a filter head; and
a replaceable disposable coreless filter element removably mounted on the reusable adaptor.

2. The spin-on filter assembly with replaceable coreless element according to claim 1 wherein the coupling for removably coupling the reusable adaptor to a filter head includes threads engagable with matching threads on the filter head.

3. The spin-on filter assembly with replaceable coreless element according to claim 2 wherein the filter bowl is threaded to the reusable adaptor.

4. The spin-on filter assembly with replaceable coreless element according to claim 3 further including radially spaced openings in the adaptor providing fluid communication between the filter head and the filter bowl.

5. The spin-on filter assembly with replaceable coreless element according to claim 4 wherein the radially spaced openings in the adaptor are configured to serve as lug receiving elements to assist in decoupling the housing from the adaptor.

6. The spin-on filter assembly with replaceable coreless element according to claim 5 wherein the replaceable disposable coreless filter element includes lugs spaced to be received in the radially spaced openings in the adaptor to assist in decoupling the housing from the adaptor.

7. The spin-on filter assembly with replaceable coreless element according to claim 6 wherein the replaceable disposable coreless filter element includes a lower endcap with an integral cross bar to which the lugs are mounted.

8. The spin-on filter assembly with replaceable coreless element according to claim 7 wherein the adaptor includes a base with filter element alignment slots on the base that receive cooperating ears on the filter element assure the filter element is properly aligned with the adaptor.

9. The spin-on filter assembly with replaceable coreless element according to claim 8 wherein the filter element alignment slots on the base that receive cooperating ears on the filter element assure the filter element is properly aligned with the adaptor of alignment are configured to be twisted into to lock the components together.

10. The spin-on filter assembly with replaceable coreless element according to claim 8 wherein the crossbar is configured whereby a screwdriver could be extended through the cross bar.

11. A spin-on filter assembly with replaceable coreless element comprising:
a reusable spin-on housing including a filter bowl;
A reusable adaptor removeably coupled to the reusable spin-on housing, including a coupling for removably coupling the reusable adaptor to a filter head, wherein the coupling for removably coupling the reusable adaptor to a filter head includes threads engagable with matching threads on the filter head, and including radially spaced openings in the adaptor providing fluid communication between the filter head and the filter bowl; and
a replaceable disposable coreless filter element removably mounted on the reusable adaptor wherein the filter assembly is inside out flow whereby the flow begins through an inlet of the filter head into the interior of the element, wherein the flow proceeds through a media of the element to the filter bowl and the flow then proceeds through the radially spaced opening in the to an outlet of the filter head.

12. The spin-on filter assembly with replaceable coreless element according to claim 11 wherein the filter bowl is threaded to the reusable adaptor.

13. The spin-on filter assembly with replaceable coreless element according to claim 12 wherein the radially spaced openings in the adaptor are configured to serve as lug receiving elements to assist in decoupling the housing from the adaptor.

14. The spin-on filter assembly with replaceable coreless element according to claim 13 wherein the radially spaced openings in the adaptor are configured to serve as lug receiving elements to assist in decoupling the housing from the adaptor.

15. The spin-on filter assembly with replaceable coreless element according to claim 14 wherein the replaceable disposable coreless filter element includes lugs spaced to be received in the radially spaced openings in the adaptor to assist in decoupling the housing from the adaptor.

16. A spin-on filter assembly with replaceable coreless element comprising:
a reusable spin-on housing including a filter bowl;
A reusable adaptor removeably coupled to the reusable spin-on housing, including a coupling for removably coupling the reusable adaptor to a filter head, wherein the coupling for removably coupling the reusable adaptor to a filter head includes threads engagable with matching threads on the filter head, and including radially spaced openings in the adaptor providing fluid communication between the filter head and the filter bowl; and
a replaceable disposable coreless filter element removably mounted on the reusable adaptor wherein the filter assembly is outside in flow whereby the flow begins through an inlet of the filter head into the interior of the bowl via the openings in the adaptor, wherein the flow proceeds through a media of the element to the interior of the element and the flow then proceeds to an outlet of the filter head.

17. The spin-on filter assembly with replaceable coreless element according to claim 16 wherein the filter bowl is threaded to the reusable adaptor.

18. The spin-on filter assembly with replaceable coreless element according to claim 17 wherein the radially spaced openings in the adaptor are configured to serve as lug receiving elements to assist in decoupling the housing from the adaptor.

19. The spin-on filter assembly with replaceable coreless element according to claim 18 wherein the radially spaced openings in the adaptor are configured to serve as lug receiving elements to assist in decoupling the housing from the adaptor.

20. The spin-on filter assembly with replaceable coreless element according to claim 19 wherein the replaceable disposable coreless filter element includes lugs spaced to be received in the radially spaced openings in the adaptor to assist in decoupling the housing from the adaptor.
